(19) United States
(12) Patent Application Publication
(10) Pub. No.: US 2024/0160237 A1
(43) Pub. Date: May 16, 2024

(54) OVERCURRENT PROTECTION CIRCUIT AND SEMICONDUCTOR DEVICE

(71) Applicant: ROHM CO., LTD., Kyoto (JP)

(72) Inventors: Makoto YASUSAKA, Kyoto (JP); Takeshi NAGATA, Kyoto (JP)

(21) Appl. No.: 18/544,977

(22) Filed: Dec. 19, 2023

Related U.S. Application Data
(63) Continuation of application No. PCT/JP2022/021091, filed on May 23, 2022.

(30) Foreign Application Priority Data
Jun. 29, 2021 (JP) 2021-107634
Jun. 29, 2021 (JP) 2021-107635

(51) Int. Cl. G05F 1/573; G05F 1/46; G05F 3/26

(52) U.S. Cl. CPC G05F 1/573; G05F 1/468; G05F 3/262

(57) ABSTRACT

An overcurrent protection circuit includes, for example, a first node to which the first electrode of an overcurrent sense resistor is connected, a second node to which the second electrode of the overcurrent sense resistor and the main electrode of an output transistor are connected, a third node to which the control electrode of the output transistor is connected, a voltage source generating a reference voltage by adding or subtracting an offset voltage to or from the terminal voltage at the first node, a hysteresis setting resistor and an overcurrent protection transistor connected in series between the second node and the third node to output a sense voltage from a fourth node between them, and an operational amplifier controlling the overcurrent protection transistor according to the difference between the reference voltage and the sense voltage.

### CROSS-REFERENCE TO RELATED APPLICATIONS

This nonprovisional application is a continuation application of International Patent Application No. PCT/JP2022/021091 filed on May 23, 2022, which claims priority Japanese Patent Applications No. 2021-107634 and No. 2021-107635 both filed on Jun. 29, 2021, the entire contents of which are hereby incorporated by reference.

### TECHNICAL FIELD

The invention disclosed herein relates to an overcurrent protection circuit, and to a semiconductor device that employs such an overcurrent protection circuit.

### BACKGROUND ART

Conventionally, overcurrent protection circuits that limit an output current flowing through an output transistor to equal to or lower than a predetermined upper limit value are widely used.

One example of conventional technology related to what has just been mentioned is seen in Patent Document 1.

### CITATION LIST

### Patent Literature

Patent Document 1: Japanese Unexamined Patent Application Publication No. 2006-115646

### BRIEF DESCRIPTION OF DRAWINGS

FIG. 1 is a diagram showing an overcurrent protection circuit of a first comparative example.

FIG. 2 is a diagram showing the overcurrent protection characteristic in the first comparative example.

FIG. 3 is a diagram showing an overcurrent protection circuit according to a first embodiment.

FIG. 4 is a diagram showing the overcurrent protection characteristic in the first embodiment.

FIG. 5 is a diagram showing a first modified example of the first embodiment.

FIG. 6 is a diagram showing a second modified example of the first embodiment.

FIG. 7 is a diagram showing an overcurrent protection circuit according to a second embodiment.

FIG. 8 is a diagram showing an overcurrent protection circuit of a second comparative example.

FIG. 9 is a diagram showing the overcurrent protection characteristic in the second comparative example.

FIG. 10 is a diagram showing an overcurrent protection circuit according to a third embodiment.

FIG. 11 is a diagram showing the overcurrent protection characteristic in the third embodiment.

FIG. 12 is a diagram showing a modified example of the third embodiment.

FIG. 13 is a diagram showing an overcurrent protection circuit according to a fourth embodiment.

FIG. 14 is a diagram showing a first application example of a semiconductor device.

FIG. 15 is a diagram showing a second application example of a semiconductor device.

### DESCRIPTION OF EMBODIMENTS

### Overcurrent Protection Circuit (First Comparative Example)

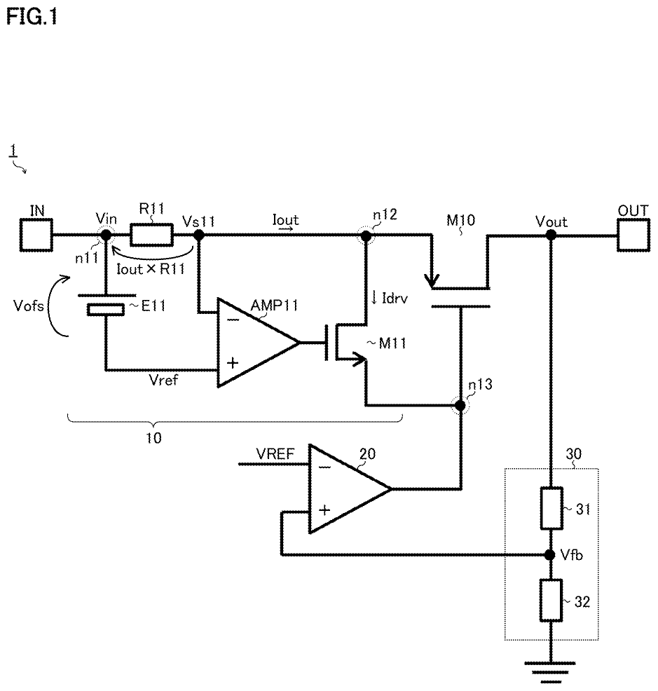

FIG. 1 is a diagram showing an overcurrent protection circuit of a first comparative example (that is, one example of a common circuit configuration to be compared with a first embodiment and a second embodiment, which will be described later).

The overcurrent protection circuit 10 of the first configuration example is a circuit block incorporated in a semiconductor device 1 along with an output transistor M10 (in the example in FIG. 1, a PMOSFET [P-channel metal-oxide-semiconductor field-effect transistor]), and includes an operational amplifier AMP1, a voltage source E11, an overcurrent protection transistor M11 (in the example in FIG. 1, an NMOSFET [N-channel MOSFET]), and an overcurrent sense resistor R11.

The semiconductor device 1 includes an input terminal IN (that is, an application terminal for an input voltage Vin) and an output terminal OUT (that is, an application terminal for an output voltage Vout) as external terminals for establishing electrical connection with the outside.

The semiconductor device 1 incorporates, in addition to the output transistor M10 and the overcurrent protection circuit 10, a driver 20 and a feedback voltage generator 30, and operates as a LDO (low-dropout) regulator.

The driver 20 drives and controls the output transistor M10 so as to generate a desired output voltage Vout from the input voltage Vin fed to the input terminal IN and output the output voltage Vout from the output terminal OUT. In terms of what is shown in FIG. 1, the driver 20 is an operational amplifier that generates a gate signal for the output transistor M10 so that a feedback voltage Vfb, which is fed to its non-inverting input terminal (+), and a reference voltage VREF, which is fed to its inverting input terminal (−), are imaginarily short-circuited together.

The feedback voltage generator 30 include resistors 31 and 32 connected in series between the output terminal OUT and a ground terminal, and divides the output voltage Vout to generate the feedback voltage Vfb. The feedback voltage generator 30 may be omitted, in which case the output voltage Vout may be fed directly to the driver 20.

The description now returns to the overcurrent protection circuit 10. The first terminal of the overcurrent sense resistor R11 and the positive terminal of the voltage source E11 are both connected to a node n11 (corresponding to a first node). The node n11 is connected to the input terminal IN. The second terminal of the overcurrent sense resistor R11, the inverting-input terminal (−) of the operational amplifier AMP11, the source of the output transistor M10, and the drain of the overcurrent protection transistor M11 are all connected to a node n12 (corresponding to a second node). The negative terminal of the voltage source E11 is connected to the non-inverting input terminal (+) of the operational amplifier AMP11. The output terminal of the operational amplifier AMP11 is connected to the gate of the overcurrent protection transistor M11. The gate of the output transistor M10 and the source of the overcurrent protection transistor M11 are both connected to a node n13 (corresponding to a third node). The drain of the output transistor M10 is connected to the output terminal OUT.

In the overcurrent protection circuit 10 of the first comparative example, the voltage source E11 generates a reference voltage Vref (=Vin−Vofs) by adding or subtracting a predetermined offset voltage Vofs to or from the input voltage Vin (the terminal voltage at the node n11).

The operational amplifier AMP11 controls the on resistance (conductivity) of the overcurrent protection transistor M11 according to the difference between the reference voltage Vref, which is fed from the negative terminal of the voltage source E11 to the non-inverting input terminal (+) of the operational amplifier AMP11, and a sense voltage Vs11, which is fed from the node n12 to the inverting input terminal (−) of the operational amplifier AMP11. The sense voltage Vs11 has a voltage value (=Vin−Iout×R11) resulting from subtracting the voltage across the overcurrent sense resistor R11 from the input voltage Vin. Thus, the sense voltage Vs11 becomes lower as an output current Iout increases and becomes higher as the output current Iout decreases.

If the voltage (=Iout×R11) across the overcurrent sense resistor R11 is lower than the offset voltage Vofs, the sense voltage Vs11 is higher than the reference voltage Vref; thus, the output signal from the operational amplifier AMP11 (that is, the gate signal for the overcurrent protection transistor M11) stays at low level. In this state, the overcurrent protection transistor M11 is fully off, so the gate-source channel of the output transistor M10 is open. Thus, the on resistance of the output transistor M10 is not raised and this brings a state where the output current Iout flowing through the output transistor M10 is not limited in any way (that is, a state where overcurrent protection operation is disabled).

By contrast, if, as a result of an increase in the output current Iout due to an output fault or the like, the voltage (=Iout×R11) across the overcurrent sense resistor R11 becomes higher than the offset voltage Vofs and the sense voltage Vs11 becomes lower than the reference voltage Vref, the output signal from the operational amplifier AMP11 rises from low level according to the difference between those two voltages. As a result, the overcurrent protection transistor M11 turns on and a driving current Idrv flows between the gate and the source of the output transistor M10; thus the gate-source voltage of the output transistor M10 is dropped. Accordingly, the on resistance of the output transistor M10 rises and this brings a state where the output current Iout is limited (that is, a state where overcurrent protection operation is enabled). Eventually, the gate control for the overcurrent protection transistor M11 enters equilibrium in a state where the sense voltage Vs11 and the reference voltage Vref are imaginarily short-circuited together.

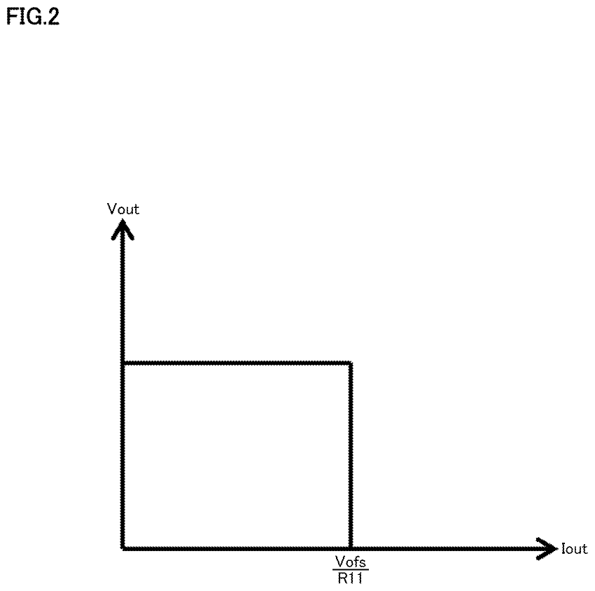

FIG. 2 is a diagram showing the overcurrent protection characteristic in the first comparative example. Note that the horizontal axis indicates the output current Iout and the vertical axis indicates the output voltage Vout.

As shown in FIG. 2, in the overcurrent protection circuit 10 of the first comparative example, what is called drooping-type output current limitation is applied so that the output current Iout does not exceed a predetermined upper limit value (≈Vofs/R11). It is here assumed that the driving current Idrv that flows during overcurrent protection operation is negligibly low compared to the output current Iout.

As described above, the overcurrent protection circuit 10 of the first comparative example can suppress an increase in the output current Iout due to an output fault or the like. Inconveniently, with a drooping overcurrent protection characteristic, for example, when the input voltage Vin is high, in the output transistor M10 tends to suffer increased heat generation (that is, power consumption). This leaves room for further improvement in terms of increased safety.

### Overcurrent Protection Circuit (First Embodiment)

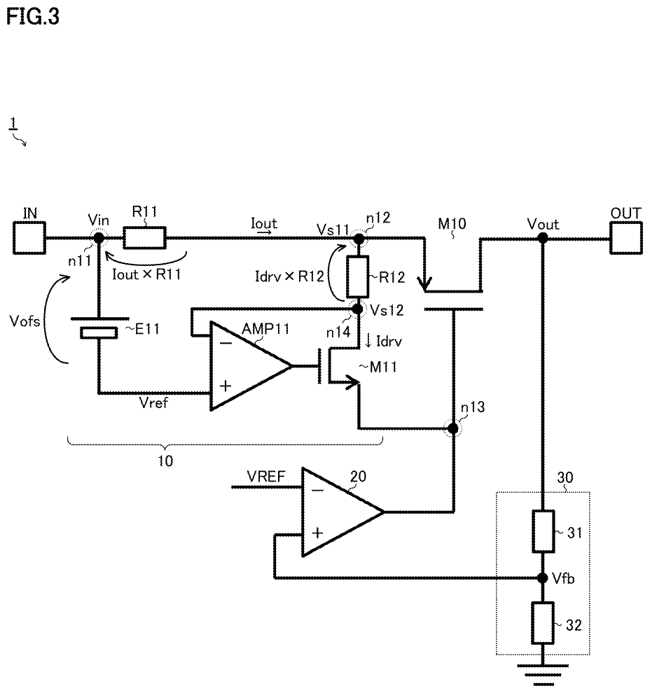

FIG. 3 is a diagram showing an overcurrent protection circuit according to a first embodiment. The overcurrent protection circuit 10 according to the first embodiment is based on the first comparative example described previously (FIG. 1) and further includes a hysteresis setting resistor R12. Thus, for the circuit elements already described, the same reference signs as in FIG. 1 will be stuck to and no overlapping description will be repeated. The following description focuses on the distinctive features of the first embodiment.

In the overcurrent protection circuit 10 of the first embodiment, between the nodes n12 and n13 described previously, the hysteresis setting resistor R12 and the overcurrent protection transistor M11 are connected in series and, from the node n14 (corresponding to a fourth node) between them, a sense voltage Vs12 is output. The connection destination of the inverting input terminal (−) of the operational amplifier AMP11 is changed from the node n12 to the node n14. Thus, the operational amplifier AMP11 controls the on resistance (conductivity) of the overcurrent protection transistor M11 according to the difference between the reference voltage Vref, which is fed to the non-inverting input terminal (+) of the operational amplifier AMP11, and the sense voltage Vs12, which is fed to the inverting input terminal (−) of the operational amplifier AMP11.

When the overcurrent protection transistor M11 is fully off, no driving current Idrv flows through the hysteresis setting resistor R12. Thus, the sense voltage Vs12 is equal to the sense voltage Vs11 (=Vin−Iout×R11). By contrast, when the over current protection transistor M11 is on, the driving current Idrv flows through the hysteresis setting resistor R12. Thus, the sense voltage Vs12 falls to a voltage value (=Vin−Iout×R11−Idrv×R12) which is lower than the sense voltage Vs11 by the voltage (=Idrv×R12) across the hysteresis setting resistor R12. As mentioned above, it is here assumed that the driving current Idrv that flows during overcurrent protection operation is negligibly low compared to the output current Iout.

First, consider a case where the overcurrent protection transistor M11 is fully off (that is, a case where overcurrent protection operation is disabled). In this case, if the voltage (=Iout×R11) across the overcurrent sense resistor R11 is lower than the offset voltage Vofs, the sense voltage Vs12 (=Vs11) is higher than the reference voltage Vref; thus, the output signal of the operational amplifier AMP11 (that is, the gate signal for the overcurrent protection transistor M11) stays at low level. In this state, the overcurrent protection transistor M11 remains fully off, so the gate-source channel of the output transistor M10 remains open. Thus, the on resistance of the output transistor M10 is not raised and this keeps a state where the output current Iout flowing through the output transistor M10 is not limited in any way (that is, a state where overcurrent protection operation is disabled).

By contrast, if, as a result of an increase in the output current Iout due to an output fault or the like, the voltage (=Iout×R11) across the overcurrent sense resistor R11 becomes higher than the offset voltage Vofs and the sense voltage Vs12 becomes lower than the reference voltage Vref, the output signal of the operational amplifier AMP11 rises from low level according to the difference between those two voltages. As a result, the overcurrent protection transistor M11 turns on and a driving current Idrv flows between the gate and the source of the output transistor M10; thus the gate-source voltage of the output transistor M10 is dropped. Accordingly, the on resistance of the output transistor M10 rises and this brings a state where the output current Iout is limited (that is, a state where overcurrent protection operation is enabled).

As mentioned above, when the driving current Idrv flows through the hysteresis setting resistor R12, the sense voltage Vs12 falls to a voltage value which is lower than the sense voltage Vs11 by the voltage (=Idrv×R12) across the hysteresis setting resistor R12. Thus, eventually, the gate control for the overcurrent protection transistor M11 enters equilibrium in a state where the sense voltage Vs12 (=Vin−Iout×R11−Idrv×R12), which is lower than the sense voltage Vs11, and the reference voltage Vref are imaginarily short-circuited together.

As described above, in the overcurrent protection circuit 10 according to the first embodiment, the operational amplifier AMP11 keeps the overcurrent protection transistor M11 fully off until the voltage (=Iout×R11) across the overcurrent sense resistor R11 exceeds the offset voltage Vofs, and once the voltage across the overcurrent sense resistor R11 exceeds the offset voltage Vofs, the operational amplifier AMP11 controls the on resistance (conductivity) of the overcurrent protection transistor M11 such that the sum voltage (=Iout×R11+Idrv×R12) resulting from adding up the voltage across the overcurrent sense resistor R11 and the voltage across the hysteresis setting resistor R12 is equal to the offset voltage Vofs.

Note that, the offset voltage Vofs is preferably set such that the voltage (=Idrv×R12) across the hysteresis setting resistor R12 during overcurrent protection operation is lower than an on threshold voltage Vth of the output transistor M10.

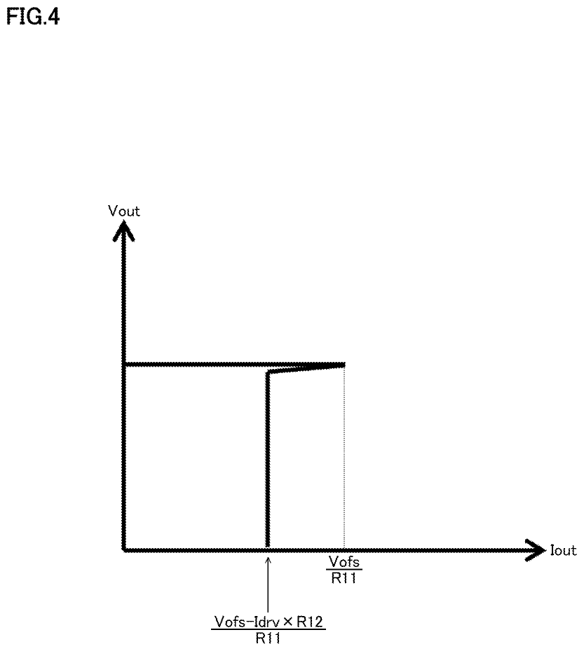

FIG. 4 is a diagram showing the overcurrent protection characteristic in the first embodiment. Note that, as in FIG. 2 referred to previously, the horizontal axis indicates the output current Iout and the vertical axis indicates the output voltage Vout.

As shown in FIG. 4, also in the overcurrent protection circuit 10 of the first embodiment, the behavior until the output current Iout reaches a predetermined overcurrent sense value (≈Vofs/R11) is no different than in the first comparative example (FIG. 2) described above. However, the behavior after the output current Iout reaches the predetermined overcurrent sense value is greatly different from that in the first comparative example (FIG. 2).

In terms of what is shown in FIG. 4, in the overcurrent protection circuit 10 of the first embodiment, once the output voltage Iout reaches the overcurrent sense value (≈Vofs/R11), what is called hysteresis-type output current limitation is applied so that the output current Iout does not exceed a predetermined upper limit value (≈(Vofs−Idrv×R12)/R11) which is lower than the overcurrent sense value.

As described above, the overcurrent protection circuit 10 of the first embodiment can suppress an increase in the output current Iout due to an output fault or the like and, in addition, it can suppress heat generation (that is, power consumption) in the output transistor M10 compared to the first comparative example with a drooping overcurrent protection characteristic (FIG. 2).

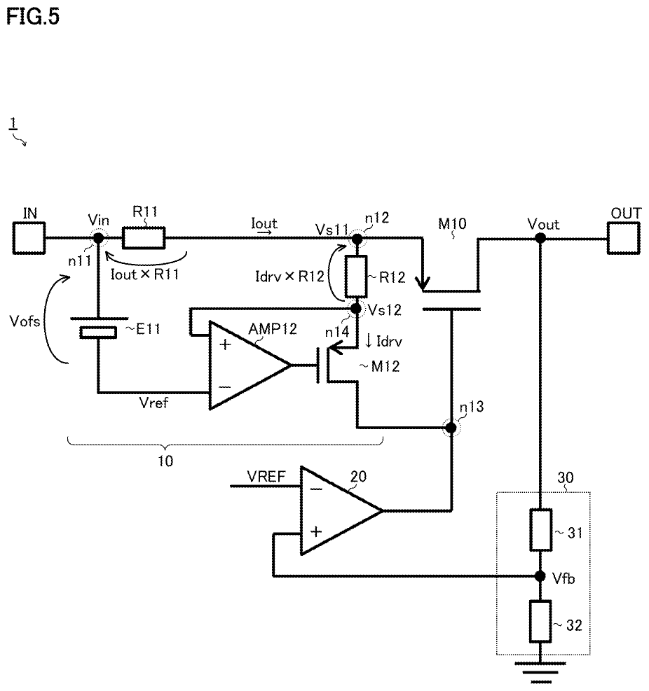

FIG. 5 is a diagram showing a first modified example of the first embodiment. As shown in FIG. 5, in the overcurrent protection circuit 10 of this modified example, instead of the N-channel overcurrent protection transistor M11, a P-channel overcurrent protection transistor M12 is used. In this case, instead of the operational amplifier AMP11 described above, an operational amplifier AMP12 with an inverted input polarity can be used.

In terms of what is shown in FIG. 5, differences in interconnection will be described. The source of the overcurrent protection transistor M12 and the non-inverting input terminal (+) of the operational amplifier AMP12 are both connected to the node n12 via the hysteresis setting resistor R12. The negative terminal of the voltage source E11 is connected to the inverting input terminal (−) of the operational amplifier AMP12. The output terminal of the operational amplifier AMP12 is connected to the gate of the overcurrent protection transistor M12. The gate of the output transistor M10 and the drain of the overcurrent protection transistor M12 are both connected to the node n13.

Also the first modified example described above provides workings and effects similar to those mentioned previously.

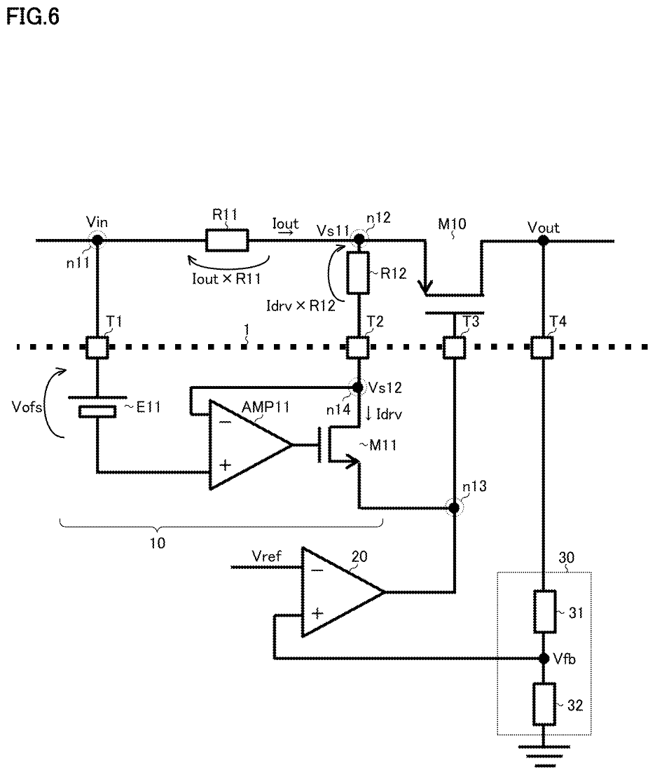

FIG. 6 is a diagram showing a second modified example of the first embodiment. As shown in FIG. 6, the output transistor M10, the overcurrent sense resistor R11, and the hysteresis setting resistor R12 may all be externally connected to the semiconductor device 1. In this case, the semiconductor device 1 may be provided with external terminals T1 to T4 for externally connecting the output transistor M10, the overcurrent sense resistor R11, and the hysteresis setting resistor R12.

In terms of what is shown in FIG. 6, outside the semiconductor device 1, the external terminal T1 is connected to the first terminal of the overcurrent sense resistor R11. The external terminal T2 is connected via the hysteresis setting resistor R12 to the second terminal of the overcurrent sense resistor R11 and to the source of the output transistor M10. The external terminal T3 is connected to the gate of the output transistor M10. The external terminal T4 is connected to the drain of the output transistor M10. On the other hand, inside the semiconductor device 1, the external terminal T1 is connected to the positive terminal of the voltage source E11. The external terminal T2 is connected to the drain of the overcurrent protection transistor M11 and the inverting input terminal (−) of the operational amplifier AMP11. The external terminal T3 is connected to the source of the overcurrent protection transistor M11. The external terminal T4 is connected to the feedback voltage generator 30. That is, the external terminals T1 to T3 can be provided so as to correspond to the previously mentioned nodes n11 to n13, respectively.

While FIG. 6 deals with an example in which the output transistor M10, the overcurrent sense resistor R11, and the hysteresis setting resistor R12 are all externally connected, the output transistor M10 and the overcurrent sense resistor R11 may each be externally connected individually. Note however that, if the hysteresis setting resistor R12 is externally connected, the overcurrent sense resistor R11 also needs to be externally connected.

### Overcurrent Protection Circuit (Second Embodiment)

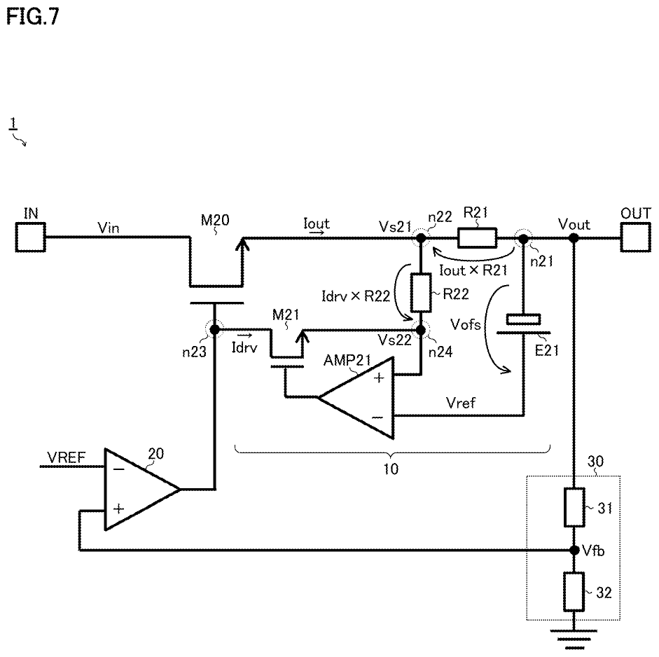

FIG. 7 is a diagram showing an overcurrent protection circuit according to a second embodiment. The overcurrent protection circuit 10 according to the second embodiment is a circuit block incorporated in a semiconductor device 1 along with an output transistor M20 (in the example in FIG. 7, an NMOSFET), and includes an operational amplifier AMP21, a voltage source E21, an overcurrent protection transistor M21 (in the example in FIG. 7, an NMOSFET), an overcurrent sense resistor R21, and a hysteresis setting resistor R22.

The first terminal of the overcurrent sense resistor R21 and the negative terminal of the voltage source E21 are both connected to a node n21 (corresponding to a first node). The node n21 is connected to the output terminal OUT. The second terminal of the overcurrent sense resistor R21, the first terminal of the hysteresis setting resistor R22, and the source of the output transistor M20 are all connected to a node n22 (corresponding to a second node). The positive terminal of the voltage source E21 is connected to the inverting input terminal (−) of the operational amplifier AMP21. The output terminal of the operational amplifier AMP21 is connected to the gate of the overcurrent protection transistor M21. The gate of the output transistor M20 and the drain of the overcurrent transistor M21 are both connected to a node n23 (corresponding to a third node). The second terminal of the hysteresis setting resistor R22, the non-inverting input terminal (+) of the operational amplifier AMP21, and the source of the overcurrent protection transistor M21 are all connected to a node n24 (corresponding to a fourth node). The drain of the output transistor M20 is connected to the input terminal IN.

In the overcurrent protection circuit 10 of the second embodiment, the voltage source E21 generates a reference voltage Vref (=Vout+Vofs) by adding or subtracting a predetermined offset voltage Vofs to or from the output voltage Vout (the terminal voltage at the node n21).

The operational amplifier AMP21 controls the on resistance (conductivity) of the overcurrent protection transistor M21 according to the difference between a sense voltage Vs22, which is fed to the non-inverting input terminal (+) of the operational amplifier AMP21, and a reference voltage Vref, which is fed to the inverting input terminal (−) of the operational amplifier AMP21.

When the overcurrent protection transistor M21 is fully off, no driving current Idrv flows through the hysteresis setting resistor R22. Thus, the sense voltage Vs22 is equal to the sense voltage Vs21 (=Vout+Iout×R21). By contrast, when the over current protection transistor M21 is on, the driving current Idrv flows through the hysteresis setting resistor R22. Thus, the sense voltage Vs22 rises to a voltage value (=Vin+Iout×R21+Idrv×R22) which is higher than the sense voltage Vs21 by the voltage (=Idrv×R22) across the hysteresis setting resistor R22. As mentioned above, it is here assumed that the driving current Idrv that flows during overcurrent protection operation is negligibly low compared to the output current Iout.

First, consider a case where the overcurrent protection transistor M21 is fully off (that is, a case where overcurrent protection operation is disabled). In this case, if the voltage (=Iout×R21) across the overcurrent sense resistor R21 is lower than the offset voltage Vofs, the sense voltage Vs22 (=Vs21) is lower than the reference voltage Vref; thus, the output signal of the operational amplifier AMP21 (that is, the gate signal for the overcurrent protection transistor M21) stays at low level. In this state, the overcurrent protection transistor M21 remains fully off, so the gate-source channel of the output transistor M20 remains open. Thus, the on resistance of the output transistor M20 is not raised and this keeps a state where the output current Iout flowing through the output transistor M20 is not limited in any way (that is, a state where overcurrent protection operation is disabled).

By contrast, if, as a result of an increase in the output current Iout due to an output fault or the like, the voltage (=Iout×R21) across the overcurrent sense resistor R21 becomes higher than the offset voltage Vofs and the sense voltage Vs22 (=Vs21) becomes higher than the reference voltage Vref, the output signal of the operational amplifier AMP21 rises from low level according to the difference between those two voltages. As a result, the overcurrent protection transistor M21 turns on and a driving current Idrv flows between the gate and the source of the output transistor M20; thus the gate-source voltage of the output transistor M20 is dropped. Accordingly, the on resistance of the output transistor M20 raises and this brings a state where the output current Iout is limited (that is, a state where overcurrent protection operation is enabled).

As mentioned above, when the driving current Idrv flows through the hysteresis setting resistor R22, the sense voltage Vs22 rises to a voltage value which is higher than the sense voltage Vs21 by the voltage (=Idrv×R22) across the hysteresis setting resistor R22. Thus, eventually, the gate control for the overcurrent protection transistor M21 enters equilibrium in a state where the sense voltage Vs22 (=Vout+Iout×R21+Idrv×R22), which is higher than the sense voltage Vs21, and the reference voltage Vref are imaginarily short-circuited together.

As described above, in the overcurrent protection circuit 10 according to the second embodiment, the operational amplifier AMP21 keeps the overcurrent protection transistor M21 fully off until the voltage (=Iout×R21) across the overcurrent sense resistor R21 exceeds the offset voltage Vofs, and once the voltage across the overcurrent sense resistor R21 exceeds the offset voltage Vofs, the operational amplifier AMP21 controls the on resistance (conductivity) of the overcurrent protection transistor M21 so that the sum voltage (=Iout×R21+Idrv×R22) resulting from adding up the voltage across the overcurrent sense resistor R21 and the voltage across the hysteresis setting resistor R22 is equal to the offset voltage Vofs.

That is, in the overcurrent protection circuit 10 of the second embodiment, once the output voltage Iout reaches the overcurrent sense value (≈Vofs/R21), what is called hysteresis-type output current limitation is applied so that the output current Iout does not exceed a predetermined upper limit value (≈(Vofs−Idrv×R22)/R21) which is lower than the overcurrent sense value.

As described above, the overcurrent protection circuit 10 of the second embodiment, like that of the first embodiment (FIG. 3) described previously, can suppress an increase in the output current Iout due to an output fault or the like and, in addition, it can suppress heat generation (power consumption) in the output transistor M20 compared to the first comparative example with a drooping overcurrent protection characteristic (FIG. 2).

Note that the offset voltage Vofs is preferably set such that the voltage (=Idrv×R22) across the hysteresis setting resistor R22 during overcurrent protection operation is lower than the on threshold voltage Vth of the output transistor M20.

Although not specifically illustrated, the output transistor M20, the overcurrent sense resistor R21, and the hysteresis setting resistor R22 may be externally connected to the semiconductor device 1 as is what is shown in FIG. 6 referred to previously.

### Overcurrent Protection Circuit (Second Comparative Example)

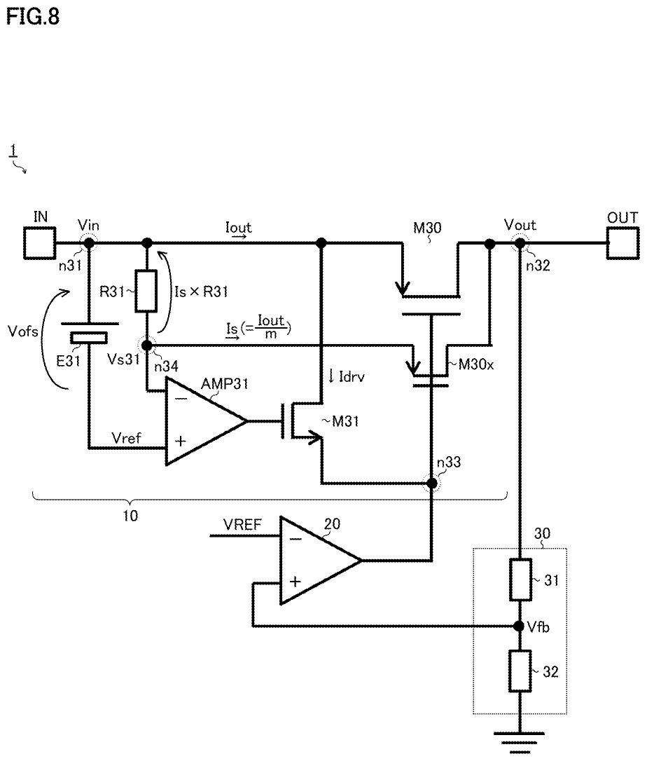

FIG. 8 is a diagram showing an overcurrent protection circuit of a second comparative example (that is, one example of a common circuit configuration to be compared with a third embodiment and a fourth embodiment, which will be described later). The overcurrent protection circuit 10 of the second comparative example is a circuit block incorporated in a semiconductor device 1 along with an output transistor M30 (in FIG. 8, a PMOSFET), and includes a mirror transistor M30x (in FIG. 8, a PMOSFET), an operational amplifier AMP31, a voltage source E31, an overcurrent protection transistor M31 (in FIG. 8, an NMOSFET), and an overcurrent sense resistor R31.

The semiconductor device 1 includes an input terminal IN (that is, an application terminal for the input voltage Vin) and an output terminal OUT (that is, an application terminal for an output voltage Vout) as external terminals for establishing electrical connection with the outside. In this regard, the configuration here is the same as that of the first comparative example (see FIG. 1) described previously.

The source of the output transistor M30, the drain of the overcurrent protection transistor M31, the first terminal of the overcurrent sense resistor R31, and the positive terminal of the voltage source E31 are all connected to a node n31 (corresponding to a first node). The node n31 is connected to the input terminal IN. The drains of the output transistor M30 and the mirror transistor M30x are both connected to a node n32 (corresponding to a second node). The node n32 is connected to the output terminal OUT. The gates of the output transistor M30 and the mirror transistor M30x and the source of the overcurrent sense resistor R31 are all connected to a node n33 (corresponding to a third node). The source of the mirror transistor M30x, the second terminal of the overcurrent sense resistor R31, and the inverting input terminal (−) of the operational amplifier AMP31 are all connected to a node n34 (corresponding to a fourth node). The negative terminal of the voltage source E31 is connected to the non-inverting input terminal (+) of the operational amplifier AMP31. The output terminal of the operational amplifier AMP31 is connected to the gate of the overcurrent protection transistor M31.

In the overcurrent protection circuit 10 of the second comparative example, the voltage source E31 generates a reference voltage Vref (=Vin−Vofs) by adding or subtracting a predetermined offset voltage Vofs to or from the input voltage Vin (the terminal voltage at the node n31).

The gate of the mirror transistor M30x and the gate of the output transistor M30 are connected together. Thus, the on resistance (conductivity) of the mirror transistor M30x is controlled so as to exhibit the same behavior as the on resistance (conductivity) of the output transistor M30 according to a gate signal applied to the node n33. As a result, a mirror current Is (=Iout/m, where m>1) proportional to the output current Iout flows through the mirror transistor M30x. The mirror current Is flows through a current path that leads from the input terminal IN to the output terminal OUT via the overcurrent sense resistor R31 and the mirror transistor M30x.

The operational amplifier AMP31 controls the on resistance (conductivity) of the overcurrent protection transistor M31 according to the difference between the reference voltage Vref, which is fed from the negative terminal of the voltage source E31 to the non-inverting input terminal (+) of the operational amplifier AMP31, and a sense voltage Vs31, which is fed from the node n34 to the inverting input terminal (−) of the operational amplifier AMP31. The sense voltage Vs31 has a voltage value (=Vin−(Iout/m)×R31) resulting from subtracting the voltage across the overcurrent sense resistor R31 from the input voltage Vin. Thus, the sense voltage Vs31 becomes lower as the output current Iout increases and becomes higher as the output current Iout decreases.

If the voltage (=(Iout/m)×R31) across the overcurrent sense resistor R31 is lower than the offset voltage Vofs, the sense voltage Vs31 is higher than the reference voltage Vref; thus, the output signal of the operational amplifier AMP31 (that is, the gate signal for the overcurrent protection transistor M31) stays at low level. In this state, the overcurrent protection transistor M31 is fully off, so the gate-source channel of the output transistor M30 is open. Thus, the on resistance of the output transistor M30 is not raised and this brings a state where the output current Iout flowing through the output transistor M30 is not limited in any way (that is, a state where overcurrent protection operation is disabled).

By contrast, if, as a result of an increase in the output current Iout due to an output fault or the like, the voltage (=(Iout/m)×R31) across the overcurrent sense resistor R31 becomes higher than the offset voltage Vofs and the sense voltage Vs31 becomes lower than the reference voltage Vref, the output signal of the operational amplifier AMP31 rises from low level according to the difference between those two voltages. As a result, the overcurrent protection transistor M31 turns on and a driving current Idrv flows between the gate and the source of the output transistor M30; thus the gate-source voltage of the output transistor M30 is dropped. Accordingly, the on resistance of the output transistor M30 raises and this brings a state where the output current Iout is limited (that is, a state where overcurrent protection operation is enabled). Eventually, the gate control for the overcurrent protection transistor M31 enters equilibrium in a state where the sense voltage Vs31 and the reference voltage Vref are imaginarily short-circuited together.

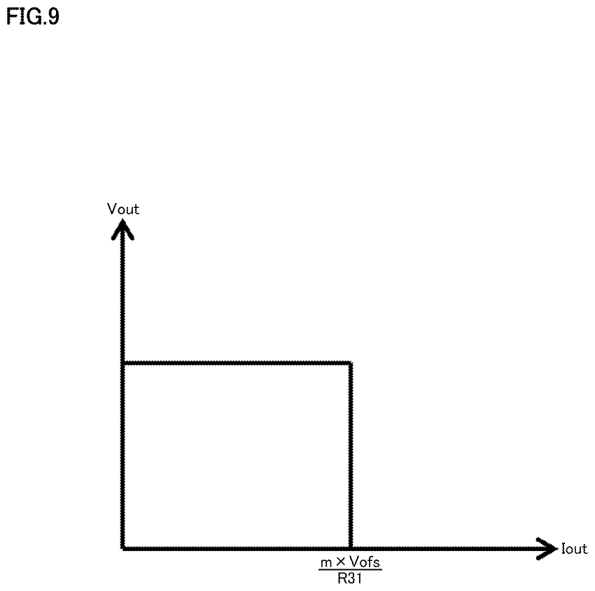

FIG. 9 is a diagram showing the overcurrent protection characteristic in the second comparative example. Note that the horizontal axis indicates the output current Iout and the vertical axis indicates the output voltage Vout.

As shown in FIG. 9, in the overcurrent protection circuit 10 of the second comparative example, what is called drooping-type output current limitation is applied so that the output current Iout does not exceed a predetermined upper limit value (≈(m×Vofs/R31)). It is here assumed that the driving current Idrv that flows during overcurrent protection operation is negligibly low compared to the output current Iout.

As described above, the overcurrent protection circuit 10 of the second comparative example can suppress an increase in the output current Iout due to an output fault or the like. Here, unlike in the first comparative example (see FIG. 1), no overcurrent sense resistor R31 is inserted in the path across which the output current Iout flows, and it is thus also possible to reduce power loss.

Inconveniently, with a drooping overcurrent protection characteristic, for example, when the input voltage Vin is high, the output transistor M30 tends to suffer increased heat generation (power consumption). This leaves room for further improvement in terms of increased safety. In this regard, the configuration here is no different from that of the first comparative example (see FIG. 2) described previously.

### Overcurrent Protection Circuit (Third Embodiment)

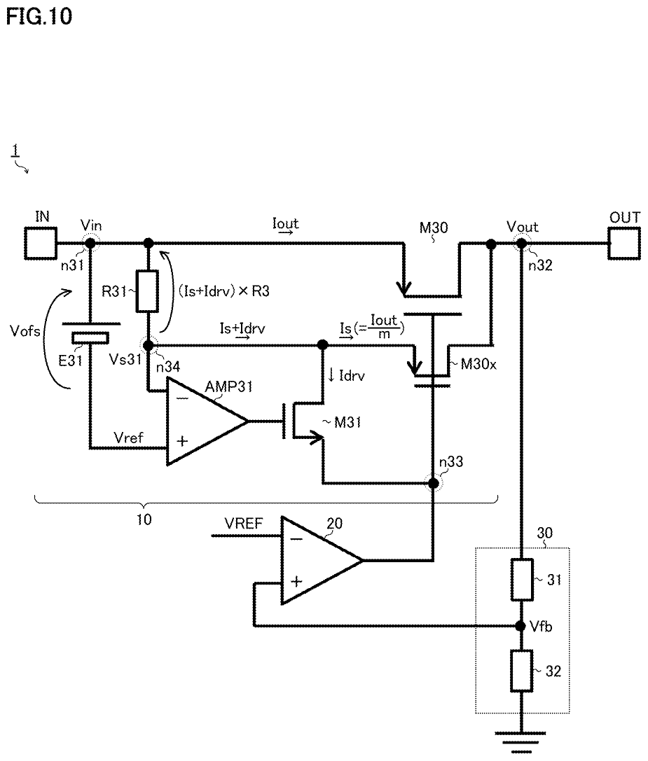

FIG. 10 is a diagram showing an overcurrent protection circuit according to a third embodiment. The overcurrent protection circuit 10 according to the third embodiment is based on the second comparative example (FIG. 8) described previously and the connection destination of the drain of the overcurrent protection transistor M31 is changed from the node n31 to the node n34. The following description focuses on the distinctive features, associated with this change, of the third embodiment.

In the overcurrent protection circuit 10 of the third embodiment, between the nodes n31 and n32 mentioned previously, the overcurrent sense resistor R31 and the mirror transistor M30x are connected in series and, from the node n34 between them, a sense voltage Vs31 is output. The operational amplifier AMP31, as described previously, controls the on resistance (conductivity) of the overcurrent protection transistor M31 according to the difference between the reference voltage Vref, which is fed from the negative terminal of the voltage source E31 to the non-inverting input terminal (+) of the operational amplifier AMP31, and the sense voltage Vs31, which is fed from the node n34 to the inverting input terminal (−) of the operational amplifier AMP31. This operation itself is no different than in the second comparative example (FIG. 8) described previously.

However, in the overcurrent protection circuit 10 of the third embodiment, as a result of the change of the connection destination of the drain of the overcurrent protection transistor M31 from the node n31 to the node n34, when the overcurrent protection transistor M31 is on, the driving current Idrv flows through a path that leads from the input terminal IN to the node n33 via the overcurrent sense resistor R31 and the overcurrent protection transistor M31. Thus, when the overcurrent protection transistor M31 is on, the sum current (=Is+Idrv) of the mirror current Is and the driving current Idrv flows through the overcurrent sense resistor R31. As a result, the overcurrent sense resistor R31 has both the functions of the overcurrent sense resistor R11 and the hysteresis setting resistor R12 in the first embodiment (FIG. 3). This will now be described specifically with reference to FIG. 10.

When the overcurrent protection transistor M31 is fully off, only the mirror current Is flows through the overcurrent sense resistor R31. Thus, the sense voltage Vs31 has a voltage value Vs31H (=Vin−(Iout/m)×R31) corresponding only to the mirror current Is. By contrast, when the over current protection transistor M31 is on, the sum current (=Is+Idrv) of the mirror current Is and the driving current Idrv flows through the overcurrent sense resistor R31. Thus, the sense voltage Vs31 has a voltage value Vs31L (=Vin−{(Iout x/m)+Idrv}×R31)) which is lower than the voltage value Vs31H mentioned above by the increase ascribable to the driving current Idrv. It is here assumed that the driving current Idrv that flows during overcurrent protection operation is negligibly low compared to the output current Iout but is not negligibly low compared to the mirror current Is.

First, consider a case where the overcurrent protection transistor M31 is fully off (that is, a case where overcurrent protection operation is disabled). In this case, if the voltage (=(Iout/m)×R31) across the overcurrent sense resistor R31 is lower than the offset voltage Vofs, the sense voltage Vs31 is higher than the reference voltage Vref; thus, the output signal of the operational amplifier AMP31 (that is, the gate signal for the overcurrent protection transistor M31) stays at low level. In this state, the overcurrent protection transistor M31 remains fully off, so the gate-source channel of the output transistor M30 remains open. Thus, the on resistance of the output transistor M30 is not raised and this keeps a state where the output current Iout flowing through the output transistor M30 is not limited in any way (that is, a state where overcurrent protection operation is disabled).

By contrast, if, as a result of an increase in the output current Iout due to an output fault or the like, the voltage (=(Iout/m)×R31) across the overcurrent sense resistor R31 becomes higher than the offset voltage Vofs and the sense voltage Vs31 becomes lower than the reference voltage Vref, the output signal of the operational amplifier AMP31 rises from low level according to the difference between those two voltages. As a result, the overcurrent protection transistor M31 turns on and a driving current Idrv flows between the gate and the source of the output transistor M30 via the overcurrent sense resistor R31 and the overcurrent protection transistor M31; thus the gate-source voltage of the output transistor M30 is dropped. Accordingly, the on resistance of the output transistor M30 rises and this brings a state where the output current Iout is limited (that is, a state where overcurrent protection operation is enabled).

As mentioned above, when the sum current (=Is+Idrv) of the mirror current Is and the driving current Idrv flows through the overcurrent sense resistor R31, the sense voltage Vs31 falls from the voltage value Vs31H to the voltage value Vs31L. Thus, eventually, the gate control for the overcurrent protection transistor M31 enters equilibrium in a state where the sense voltage Vs31 with the voltage value Vs31L (=Vin−{(Iout/m)+Idrv}×R31) and the reference voltage Vref are imaginarily short-circuited together.

As described above, in the overcurrent protection circuit 10 according to the third embodiment, the operational amplifier AMP31 keeps the overcurrent protection transistor M31 fully off until the voltage (=(Iout/m)×R31) across the overcurrent sense resistor R31 corresponding only to the mirror current Is exceeds the offset voltage Vofs, and once the voltage across the overcurrent sense resistor R31 corresponding only to the mirror current Is exceeds the offset voltage Vofs, the operational amplifier AMP31 controls the on resistance (conductivity) of the overcurrent protection transistor M31 such that the voltage (={(Iout/m)+Idrv}×R31) across the overcurrent sense resistor R31 corresponding to the sum current (=Is+Idrv) of the mirror current Is and the driving current Idrv is equal to the offset voltage Vofs.

Note that the offset voltage Vofs is preferably set such that the voltage (={(Iout/m)+Idrv}×R31) across the overcurrent sense resistor R31 during overcurrent protection operation is lower than the on threshold voltage Vth of the output transistor M30.

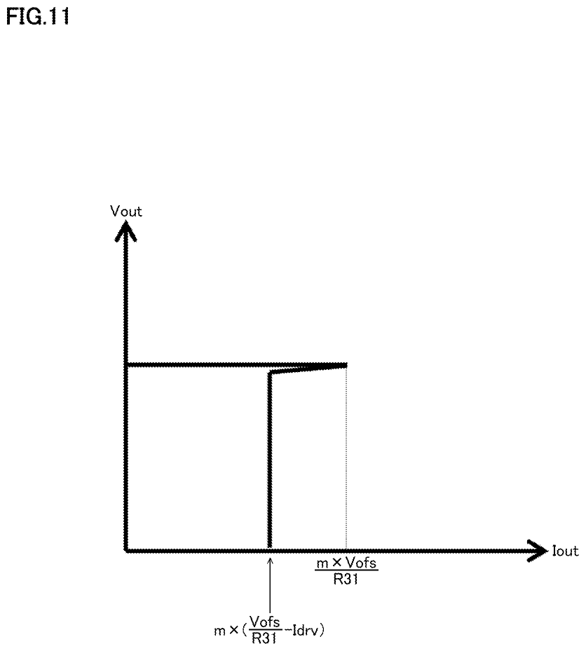

FIG. 11 is a diagram showing the overcurrent protection characteristic in the third embodiment. Note that, as in FIG. 9 referred to previously, the horizontal axis indicates the output current Iout and the vertical axis indicates the output voltage Vout.

As shown in FIG. 11, also in the overcurrent protection circuit 10 of the third embodiment, the behavior until the output current Iout reaches the predetermined overcurrent sense value (≈m×Vofs/R31) is no different than in the second comparative example (FIG. 9) described previously. However, the behavior after the output current Iout reaches the predetermined overcurrent sense value is greatly different from that in the second comparative example (FIG. 9) described previously.

In terms of what is shown in FIG. 11, in the overcurrent protection circuit 10 of the third embodiment, once the output voltage Iout reaches the overcurrent sense value (≈m×Vofs/R31), what is called hysteresis-type output current limitation is applied so that the output current Iout does not exceed a predetermined upper limit value (≈m×{(Vofs/R31)−Idrv}) which is lower than the overcurrent sense value.

As described above, the overcurrent protection circuit 10 of the third embodiment can suppress an increase in the output current Iout due to an output fault or the like and, in addition, it can suppress heat generation (that is, power consumption) in the output transistor M30 compared to the second comparative example (FIG. 9) with a drooping overcurrent protection characteristic. Here, unlike in the first embodiment (FIG. 3), no overcurrent sense resistor R31 is inserted in the path across which the output current Iout flows, and it is thus also possible to reduce power loss.

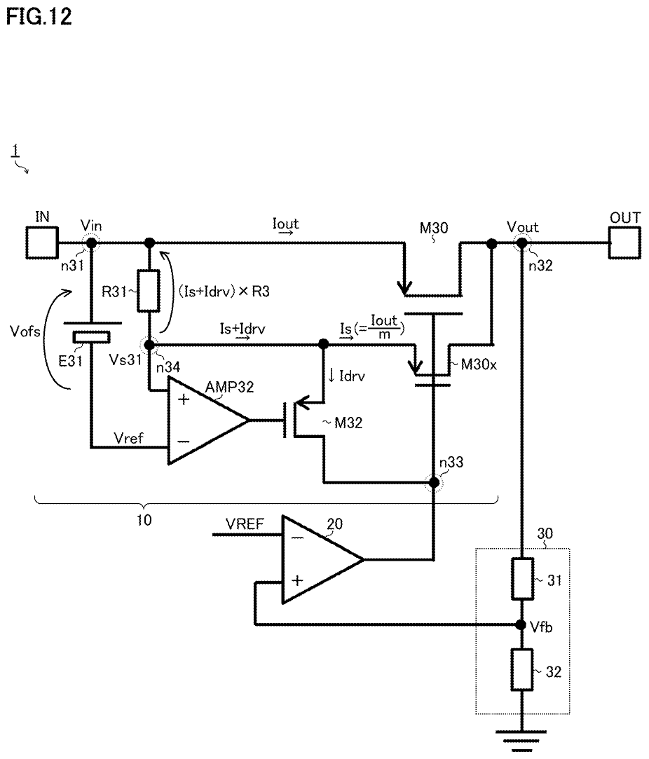

FIG. 12 is a diagram showing a modified example of the third embodiment. As shown in FIG. 12, in the overcurrent protection circuit 10 of this modified example, instead of the N-channel overcurrent protection transistor M31, a P-channel overcurrent protection transistor M32 is used. In this case, instead of the operational amplifier AMP31 described above, an operational amplifier AMP32 with inverted input polarities can be used.

In terms of what is shown in FIG. 12, differences in interconnection will be described. The source of the overcurrent protection transistor M32 and the non-inverting input terminal (+) of the operational amplifier AMP32 are both connected to the node n34. The negative terminal of the voltage source E31 is connected to the inverting input terminal (−) of the operational amplifier AMP32. The output terminal of the operational amplifier AMP32 is connected to the gate of the overcurrent protection transistor M32. The gates of the output transistor M30 and the mirror transistor M30x and the drain of the overcurrent protection transistor M32 are all connected to the node n33.

Also this modified example described above provides workings and effects similar to those mentioned previously.

### Overcurrent Protection Circuit (Fourth Embodiment)

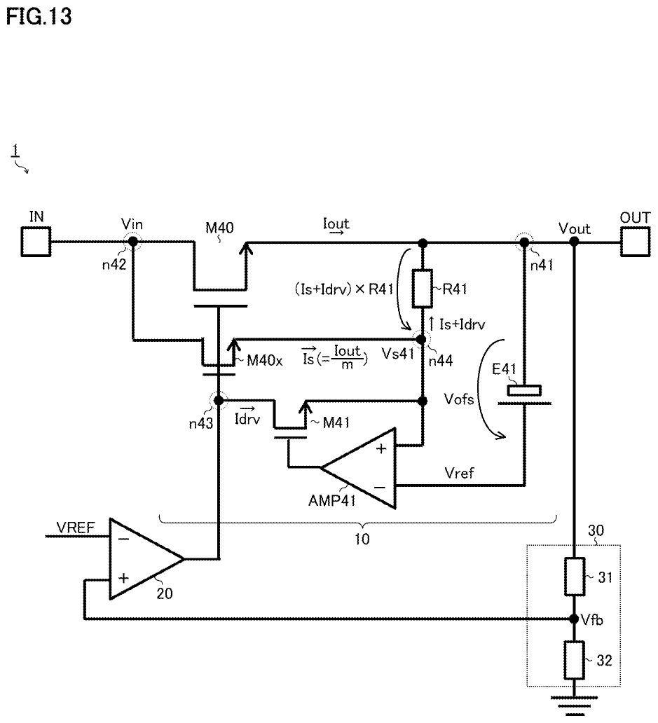

FIG. 13 is a diagram showing an overcurrent protection circuit according to a fourth embodiment. The overcurrent protection circuit 10 according to the fourth embodiment is a circuit block incorporated in a semiconductor device 1 along with an output transistor M40 (in FIG. 13, an NMOSFET), and includes a mirror transistor M40x (in FIG. 13, an NMOSFET), an operational amplifier AMP41, a voltage source E41, an overcurrent protection transistor M41 (in FIG. 13, an NMOSFET), and an overcurrent sense resistor R41.

The source of the output transistor M40, the first terminal of the overcurrent sense resistor R41, and the negative terminal of the voltage source E41 are all connected to a node n41 (corresponding to a first node). The node n41 is connected to the output terminal OUT. The drains of the output transistor M40 and the mirror transistor M40x are both connected to a node n42 (corresponding to a second node). The node n42 is connected to the input terminal IN. The gates of the output transistor M40 and the mirror transistor M40x and the drain of the overcurrent transistor M41 are all connected to a node n43 (corresponding to a third node). The sources of the mirror transistor M40x and the overcurrent protection transistor M41, the second terminal of the overcurrent sense resistor R41, and the non-inverting input terminal (+) of the operational amplifier AMP41 are all connected to a node n44 (corresponding to a fourth node). The positive terminal of the voltage source E41 is connected to the inverting input terminal (−) of the operational amplifier AMP41. The output terminal of the operational amplifier AMP41 is connected to the gate of the overcurrent protection transistor M41.

In the overcurrent protection circuit 10 of the fourth embodiment, the voltage source E41 generates a reference voltage Vref (=Vout+Vofs) by adding or subtracting a predetermined offset voltage Vofs to or from the output voltage Vout (the terminal voltage at the node n41).

The gate of the mirror transistor M40x and the gate of the output transistor M40 are connected together. Thus, the on resistance (conductivity) of the mirror transistor M40x is controlled so as to exhibit the same behavior as the on resistance (conductivity) of the output transistor M40 according to a gate signal applied to the node n43. As a result, a mirror current Is (=Iout/m, where m>1) proportional to the output current Iout flows through the mirror transistor M40x. The mirror current Is flows through a current path that leads from the input terminal IN to the output terminal OUT via the mirror transistor M40x and the overcurrent sense resistor R41.

The operational amplifier AMP41 controls the on resistance (conductivity) of the overcurrent protection transistor M41 according to the difference between the reference voltage Vref, which is fed from the positive terminal of the voltage source E41 to the inverting input terminal (−) of the operational amplifier AMP41, and a sense voltage Vs41, which is fed from the node n44 to the non-inverting input terminal (+) of the operational amplifier AMP41.

When the overcurrent protection transistor M41 is fully off, only the mirror current Is flows through the overcurrent sense resistor R41. Thus, the sense voltage Vs41 has a voltage value Vs41L (=Vout+(Iout/m)×R41) corresponding only to the mirror current Is. By contrast, when the over current protection transistor M41 is on, the sum current (=Is+Idrv) of the mirror current Is and the driving current Idrv flows through the overcurrent sense resistor R41. Thus, the sense voltage Vs41 has a voltage value Vs41H (=Vout+{(Iout/m)+Idrv}×R41)) which is higher than the voltage value Vs41H mentioned above by the increase ascribable to the driving current Idrv. It is here assumed that the driving current Idrv that flows during overcurrent protection operation is negligibly low compared to the output current Iout but is not negligibly low compared to the mirror current Is.

First, consider a case where the overcurrent protection transistor M41 is fully off (that is, a case where overcurrent protection operation is disabled). In this case, if the voltage (=(Iout/m)×R41) across the overcurrent sense resistor R41 is lower than the offset voltage Vofs, the sense voltage Vs41 is lower than the reference voltage Vref; thus, the output signal of the operational amplifier AMP41 (that is, the gate signal for the overcurrent protection transistor M41) stays at low level. In this state, the overcurrent protection transistor M41 remains fully off, so the gate-source channel of the output transistor M40 remains open. Thus, the on resistance of the output transistor M40 is not raised and this keeps a state where the output current Iout flowing through the output transistor M40 is not limited in any way (that is, a state where overcurrent protection operation is disabled).

By contrast, if, as a result of an increase in the output current Iout due to an output fault or the like, the voltage (=(Iout/m)×R41) across the overcurrent sense resistor R41 becomes higher than the offset voltage Vofs and the sense voltage Vs41 becomes higher than the reference voltage Vref, the output signal of the operational amplifier AMP41 rises from low level according to the difference between those two voltages. As a result, the overcurrent protection transistor M41 turns on and a driving current Idrv flows between the gate and the source of the output transistor M40 via the overcurrent sense resistor R41 and the overcurrent protection transistor M41; thus the gate-source voltage of the output transistor M40 is dropped. Accordingly, the on resistance of the output transistor M40 rises and this brings a state where the output current Iout is limited (that is, a state where overcurrent protection operation is enabled).

As mentioned above, when the sum current (=Is+Idrv) of the mirror current Is and the driving current Idrv flows through the overcurrent sense resistor R41, the sense voltage Vs41 rises from the voltage value Vs41L to the voltage value Vs41H. Thus, eventually, the gate control for the overcurrent protection transistor M41 enters equilibrium in a state where the sense voltage Vs41 with the voltage value Vs41H (=Vin+{(Iout/m)+Idrv}×R41) and the reference voltage Vref are imaginarily short-circuited together.

As described above, in the overcurrent protection circuit 10 according to the fourth embodiment, the operational amplifier AMP41 keeps the overcurrent protection transistor M41 fully off until the voltage (=(Iout/m)×R41) across the overcurrent sense resistor R41 corresponding only to the mirror current Is exceeds the offset voltage Vofs, and once the voltage across the overcurrent sense resistor R41 corresponding only to the mirror current Is exceeds the offset voltage Vofs, the operational amplifier AMP41 controls the on resistance (conductivity) of the overcurrent protection transistor M41 such that the voltage (={(Iout/m)+Idrv}×R41) across the overcurrent sense resistor R41 corresponding to the sum current (=Is+Idrv) of the mirror current Is and the driving current Idrv is equal to the offset voltage Vofs.

Note that the offset voltage Vofs is preferably set such that the voltage (={(Iout/m)+Idrv}×R41) across the overcurrent sense resistor R41 during overcurrent protection operation is lower than the on threshold voltage Vth of the output transistor M40.

<Application Example of Semiconductor Device>

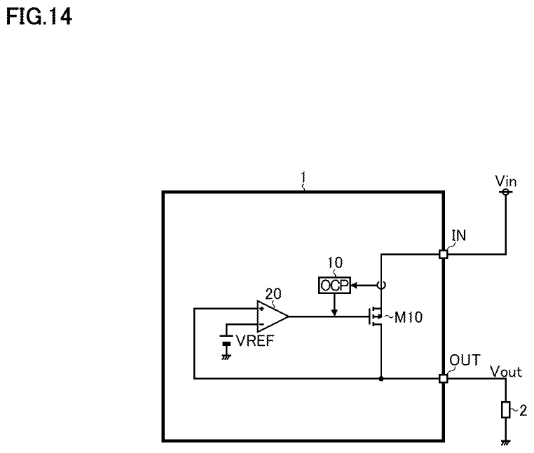

FIG. 14 is a diagram showing a first application example (as a LDO [low-dropout] regulator) of the semiconductor device 1. As shown in FIG. 14, the semiconductor device 1 of the first application example has a similar configuration as that in the first embodiment (FIG. 3) described previously; it drives and controls the output transistor M10 so as to generate from the input voltage Vin fed to the input terminal IN a desired output voltage Vout and feed it to a load 2 connected externally to the output terminal OUT.

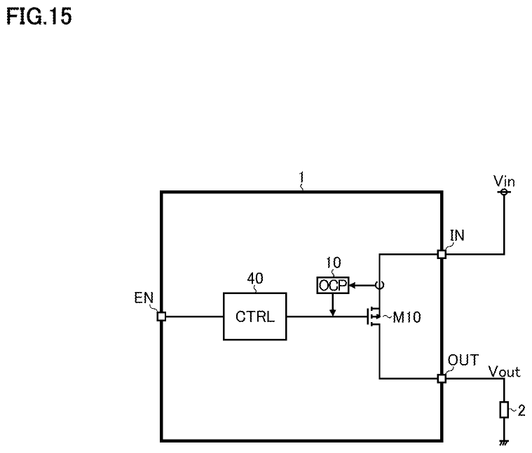

FIG. 15 is a diagram showing a second application example (as a load switch) of the semiconductor device 1. As shown in FIG. 15, the semiconductor device 1 of the second application example is based on the first embodiment (FIG. 3) and incorporates a controller 40 instead of the driver 20.

The controller 40 turns the output transistor M10 on and off according to an enable signal fed to an enable terminal EN from the outside.

While FIG. 15 deals with an example in which the semiconductor device 1 is used as a high-side switch, the semiconductor device 1 may be used as a low-side switch.

Although not specifically illustrated, also any of the semiconductor devices 1 of the second embodiment (FIG. 7), the third embodiment (FIG. 10), and the fourth embodiment (FIG. 13) may be applied as a LDO regulator or a high-side switch (or a low-side switch).

For example, in FIGS. 14 and 15, only the output transistor M10 is illustrated as a target to be driven by the driver 20 and the controller 40; however when the semiconductor device 1 of the third embodiment (FIG. 10) is used instead of that of the first embodiment (FIG. 3), that is, when the overcurrent protection circuit 10 includes the mirror transistor M30x, both the output transistor M30 and the mirror transistor M30x are a target to be driven by the driver 20 and the controller 40, and synchronous driving control is performed by the driver 20 and the controller 40.

<Notes>

To follow is an overview of the various embodiments described herein.

For example, according to one aspect of what is disclosed herein, an overcurrent protection circuit includes a first node configured to have connected to it the first electrode of an overcurrent sense resistor, a second node configured to have connected to it the second electrode of the overcurrent sense resistor and to the main electrode of an output transistor, a third node configured to have connected to it the control electrode of the output transistor, a voltage source configured to generate a reference voltage by adding or subtracting an offset voltage to or from the terminal voltage at the first node, a hysteresis setting resistor and an overcurrent protection transistor connected in series between the second and third nodes and configured to output a sense voltage from a fourth node between the second and third nodes, and an operational amplifier configured to control the overcurrent protection transistor according to the difference between the reference voltage and the sense voltage. (A first configuration).

In the overcurrent protection circuit of the first configuration described above, the operational amplifier may keep the overcurrent protection transistor fully off until the voltage across the overcurrent sense resistor exceeds the offset voltage, and once the voltage across the overcurrent sense resistor exceeds the offset voltage, the operational amplifier may control the on resistance of the overcurrent protection transistor such that the sum voltage resulting from adding up the voltage across the overcurrent sense resistor and the voltage across the hysteresis setting resistor is equal to the offset voltage. (A second configuration).

In the overcurrent protection circuit of the first or second configurations described above, the offset voltage may be set such that the voltage across the hysteresis setting resistor during the overcurrent protection operation is lower than the on threshold voltage of the output transistor. (A third configuration).

For example, according to another aspect of what is disclosed herein, a semiconductor device includes the overcurrent protection circuit according to any one of the first to third configurations. (A fourth configuration.)

The semiconductor device of the fourth configuration described above may incorporate both the output transistor and the overcurrent sense resistor. (A fifth configuration.)

The semiconductor device of the fourth configuration described above may include a plurality of external terminals configured to have externally connected to them the output transistor and the overcurrent sense resistor. (A sixth configuration).

The semiconductor device of any one of the fourth to sixth configurations described above may further include a driver that drives and controls the output transistor so as to generate a desired output voltage from an input voltage. (A seventh configuration).

The semiconductor device of any one of the fourth to sixth configurations described above may further include a controller that turns the output transistor on and off according to an enable signal. (An eighth configuration).

For example, according to yet another aspect of what is disclosed herein, an overcurrent protection circuit includes a first node configured to have connected to it the first main electrode of an output transistor, a second node configured to have connected to it the second main electrode of the output transistor, a third node configured to have connected to it the control electrode of the output transistor, a voltage source configured to generate a reference voltage by adding or subtracting an offset voltage to or from the terminal voltage at the first node, an overcurrent sense resistor and a mirror transistor connected in series between the first and second nodes and configured to output a sense voltage from a fourth node between the first and second nodes, an overcurrent protection transistor configured to be connected between the fourth and third nodes, and an operational amplifier configured to control the overcurrent protection transistor according to the difference between the reference voltage and the sense voltage. (A ninth configuration).

In the overcurrent protection circuit of the ninth configuration described above, the operational amplifier may keep the overcurrent protection transistor fully off until the voltage across the overcurrent sense resistor exceeds the offset voltage, and once the voltage across the overcurrent sense resistor exceeds the offset voltage, the operational amplifier may control the on resistance of the overcurrent protection transistor such that the voltage across the overcurrent sense resistor is equal to the offset voltage. (A tenth configuration).

In the overcurrent protection circuit of the ninth or tenth configurations described above, the offset voltage may be set such that the voltage across the overcurrent sense resistor during the overcurrent protection operation is lower than the on threshold voltage of the output transistor. (An eleventh configuration).

For example, according to still another aspect of what is disclosed herein, a semiconductor device includes the output transistor and the overcurrent protection circuit according to any one of the ninth to eleventh configurations. (A twelfth configuration).

The semiconductor device of the twelfth configuration described above may further include a driver that drives and controls the output transistor and the mirror transistor so as to generate a desired output voltage from an input voltage. (A thirteenth configuration.)

The semiconductor device of the twelfth configuration described above may further include a controller that turns the output transistor and the mirror transistor on and off according to an enable signal. (A thirteenth configuration.)

### OTHER MODIFIED EXAMPLES

The various technical features disclosed herein can be implemented in any manners other than as in the above-described embodiments with any modifications made without departure from the spirit of the technical creations. For example, bipolar transistors and MOS field-effect transistors can be replaced with each other or the logic levels of various signals can be inverted as necessary. That is, it should be understood that the above-described embodiments are in every aspect illustrative and not restrictive. The technical scope of the present invention is defined not by the description of the embodiments given above but by the appended claims, and encompasses any modifications made within a scope equivalent in significance to those claims.

1. An overcurrent protection circuit comprising:
a first node configured to have connected thereto a first electrode of an overcurrent sense resistor;
a second node configured to have connected thereto a second electrode of the overcurrent sense resistor and a main electrode of an output transistor;
a third node configured to have connected thereto a control electrode of the output transistor;
a voltage source configured to generate a reference voltage by adding or subtracting an offset voltage to or from a terminal voltage at the first node;
a hysteresis setting resistor and an overcurrent protection transistor connected in series between the second and third nodes and configured to output a sense voltage from a fourth node between the second and third nodes; and
an operational amplifier configured to control the overcurrent protection transistor according to a difference between the reference voltage and the sense voltage.

2. The overcurrent protection circuit according to claim 1, wherein
the operational amplifier keeps the overcurrent protection transistor fully off until a voltage across the overcurrent sense resistor exceeds the offset voltage, and once the voltage across the overcurrent sense resistor exceeds the offset voltage, the operational amplifier controls an on resistance of the overcurrent protection transistor such that a sum voltage resulting from adding up the voltage across the overcurrent sense resistor and a voltage across the hysteresis setting resistor is equal to the offset voltage.

3. The overcurrent protection circuit according to claim 1, wherein
the offset voltage is set such that the voltage across the hysteresis setting resistor during overcurrent protection operation is lower than an on threshold voltage of the output transistor.

4. A semiconductor device comprising:
the overcurrent protection circuit according to claim 1.

5. The semiconductor device according to claim 4, wherein
the semiconductor device incorporates both the output transistor and the overcurrent sense resistor.

6. The semiconductor device according to claim 4, comprising:
a plurality of external terminals configured to have externally connected thereto the output transistor and the overcurrent sense resistor.

7. The semiconductor device according to claim 4, further comprising:
a driver that drives and controls the output transistor so as to generate a desired output voltage from an input voltage.

8. The semiconductor device according to claim 4, further comprising:
a controller that turns the output transistor on and off according to an enable signal.

9. An overcurrent protection circuit comprising:
a first node configured to have connected thereto a first main electrode of an output transistor;
a second node configured to have connected thereto a second main electrode of the output transistor;
a third node configured to have connected thereto a control electrode of the output transistor;
a voltage source configured to generate a reference voltage by adding or subtracting an offset voltage to or from a terminal voltage at the first node;
an overcurrent sense resistor and a mirror transistor connected in series between the first and second nodes and configured to output a sense voltage from a fourth node between the first and second nodes;
an overcurrent protection transistor configured to be connected between the fourth and third nodes; and
an operational amplifier configured to control the overcurrent protection transistor according to a difference between the reference voltage and the sense voltage.

10. The overcurrent protection circuit according to claim 9, wherein
the operational amplifier keeps the overcurrent protection transistor fully off until a voltage across the overcurrent sense resistor exceeds the offset voltage, and once the voltage across the overcurrent sense resistor exceeds the offset voltage, the operational amplifier controls an on resistance of the overcurrent protection transistor such that the voltage across the overcurrent sense resistor is equal to the offset voltage.

11. The overcurrent protection circuit according to claim 9, wherein
the offset voltage is set such that the voltage across the overcurrent sense resistor during overcurrent protection operation is lower than an on threshold voltage of the output transistor.

12. A semiconductor device comprising:
the output transistor; and
the overcurrent protection circuit according to claim 9.

13. The semiconductor device according to claim 12, further comprising:
a driver that drives and controls the output transistor and the mirror transistor so as to generate a desired output voltage from an input voltage.

14. The semiconductor device according to claim 12, further comprising:
a controller that turns the output transistor and the mirror transistor on and off according to an enable signal.
